(19) United States
(12) Patent Application Publication
(10) Pub. No.: US 2009/0320024 A1
(43) Pub. Date: Dec. 24, 2009

(54) CONTROL DEVICE AND CONTROL METHOD THEREOF

(75) Inventors: Ju-il EOM, Suwon-si (KR); Seung-dong YU, Osan-si (KR); Woo-yong CHANG, Yongin-si (KR); Dae-hyun KIM, Suwon-si (KR); Eun-hee PARK, Suwon-si (KR); Chang-hwan HWANG, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/365,290

(22) Filed: Feb. 4, 2009

(30) Foreign Application Priority Data
Jun. 23, 2008 (KR) 10-2008-0059117

(51) Int. Cl. G06F 9/46

(52) U.S. Cl. 718/100

(57) ABSTRACT

A control device for displaying a menu generated based on the media included in the devices within a home network. The control device includes a media information collection unit which collects information on media that can be processed by devices within a home network, a control unit which generates a task list for tasks that can be performed based on the collected information, and a display unit which displays the generated task list. A user thereby may control the devices within a home network using the menu generated based on the media included in the devices, making it possible to improve convenience to the user.

### CROSS-REFERENCE TO RELATED APPLICATIONS

This application claims priority from Korean Patent Application No. 10-2008-0059117, filed on Jun. 23, 2008, in the Korean Intellectual Property Office, the disclosure of which is incorporated herein by reference in its entirety.

### BACKGROUND OF THE INVENTION

1. Field of the Invention

Apparatuses and methods consistent with the present invention relate to providing a control device and a control method thereof, and more particularly, to providing a control device which displays a menu generated based on media included in devices within a home network, and a control method thereof.

2. Description of the Related Art

Up until now, when a user has desired to play back a disk using a disk reproduction device which is able to be connected to a home network centered on a television, a user has been unable to check whether the disk to be played back is currently inserted into the device. More specifically, in the related art, the user must open a tray of the corresponding device or check the disk by directly playing back the corresponding medium in order to check the disk to be played back, causing inconvenience to the user.

In particular, as the number of the media reproduction devices connected to a home network has increased with the development of image and audio media, the number of devices that the user should check has also increased, so the inconvenience to the user has increased even more.

Even after checking into which device the disk to be played back is inserted, when several devices are used for playing back the corresponding disk, the user must perform necessary operations using remote controllers for every device in order to operate the devices, causing inconvenience to the user.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a control device which displays a menu generated based on media included in devices within a home network, and a control method thereof

According to an aspect of the present invention, there is provided a control device comprising a media information collection unit which collects information on media that can be processed by devices within a home network, a control unit which generates a task list for tasks that can be performed based on the collected information, and a display unit which displays the generated task list.

When the collected information includes the types of media, the display unit may display the tasks using icons corresponding to each type of media.

When a task is selected from the task list, the control unit may control processing operations for the media corresponding to the selected task.

When the device that can perform the selected task has a plurality of operational modes, the control unit may control the device to operate in an operational mode corresponding to the selected task.

The media information collection unit may collect information on media periodically or according to user commands, and the control unit may update the task list according to the collected information.

The control unit may collect information on the types of media included in the respective devices to generate a task list.

The control unit may collect the titles of content included in the respective devices to generate a task list.

The media information collection unit may collect information on media included in the devices by receiving the information on media directly from the devices.

The media information collection unit may collect information on media included in the devices by receiving the information on media indirectly from one of the devices.

According to another aspect of the present invention, there is provided a control method comprising collecting information on media that can be processed by devices within a home network, generating a task list for tasks that can be performed based on the collected information, and displaying the generated task list.

The displaying the generated task list may comprise displaying the tasks using icons corresponding to each type of media, when the collected information includes the types of media.

The control method may further comprise controlling processing operations for the media corresponding to the selected task, when a task is selected from the task list.

The controlling the processing operations may comprise controlling a device to operate in an operational mode corresponding to the selected task, when the device that can perform the selected task has a plurality of operational modes.

The collecting the information may comprise collecting information on media periodically or according to user commands, and the generating the task list may comprise updating the task list according to the collected information.

The generating the task list may comprise collecting information on the types of media in the respective devices to generate a task list.

The generating the task list may comprise collecting the titles of content included on the respective devices to generate a task list.

The collecting the information may comprise collecting information on media included in the devices by receiving the information on media directly from the devices.

The collecting of the information may comprise collecting information on media included in the devices by receiving the information on media indirectly from one of the devices.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram showing a configuration of a control device according to an exemplary embodiment of the present invention;

FIGS. 2 and 3 are diagrams showing a configuration of a home network system including the control device of FIG. 1 according to an exemplary embodiment of the present invention;

FIGS. 4 and 5 are diagrams showing a tasks display method according to an exemplary embodiment of the present invention;

FIGS. 6 and 7 are diagrams showing detailed embodiments of display shapes according to FIGS. 4 and 5;

FIG. 8 is a flowchart explaining a control method of a control device according to an exemplary embodiment of the present invention; and

FIG. 9 is a detailed flowchart explaining the operations of generating tasks according to an exemplary embodiment of the present invention.

### DETAILED DESCRIPTION OF EXEMPLARY EMBODIMENTS

Certain exemplary embodiments of the present invention will now be described in greater detail with reference to the accompanying drawings.

In the following description, the same drawing reference numerals are used for the same elements even in different drawings. The matters defined in the description, such as the detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

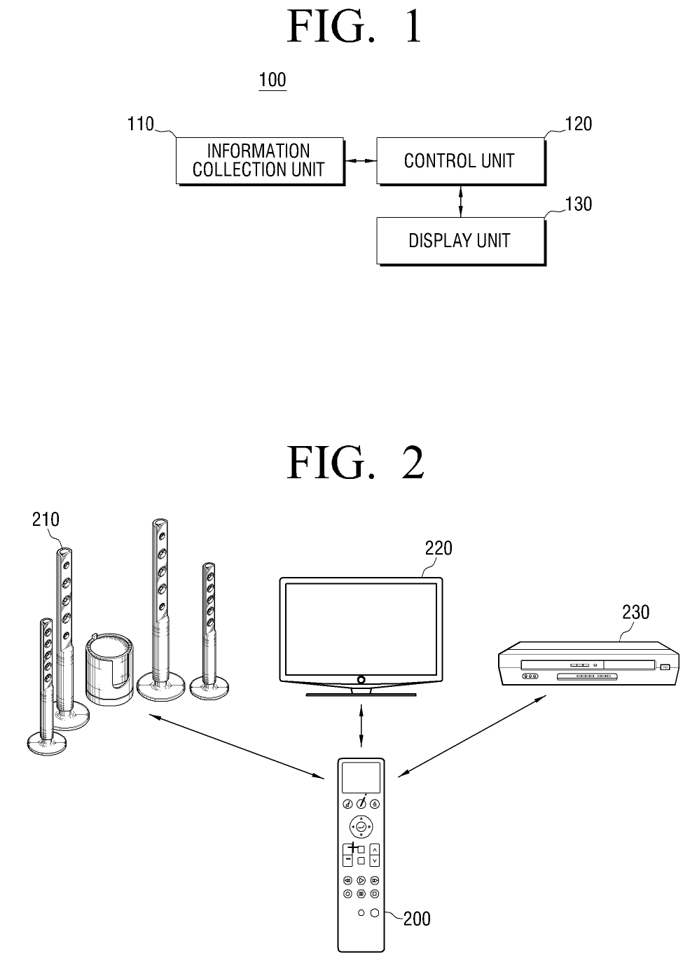

FIG. 1 is a block diagram showing a configuration of a control device according to an exemplary embodiment of the present invention. Referring to FIG. 1, a control device 100 includes a media information collection unit 110, a control unit 120, and a display unit 130. The control device may be implemented as a digital television, a remote controller, or the like.

When the control device 100 is implemented as a remote controller, the control device 100 can perform two-way communications with a plurality of devices within a home network, thereby receiving information on media directly from the respective device and allowing the remote controller to control the respective device directly. Here, the two-way communications may include all currently existing communication technologies such as BlueTooth (BT), Radio Frequency (RF), High Fidelity (HI-FI), High Definition Mutimedia Interface (HDMI-CEC), Wireless HDMI-CEC, or the like, or any future two-way communication technologies.

The control device 100 may also be implemented as a remote controller which controls a digital TV capable of controlling a plurality of devices. In this case, the control device 100 may be indirectly connected to other devices using a server such as a digital TV which becomes the center of the plurality of devices. In other words, as the remote controller controls the digital TV, the control device 100 may be formed to control the plurality of devices connected to the digital TV.

The control device 100 may also be implemented as a predetermined device within a home network instead of the remote controller, for example, a digital TV. In this case, the digital TV is implemented to enable two-way communications with other devices within the home network, so the digital TV may be formed to control a plurality of devices connected thereto.

Here, the plurality of devices may include diverse types of devices that can be connected to each device within the home network, such as a TV, a Set-Top-Box (STB), a Home Theater System (HTS), a Blue-ray Disc Player (BDP), a DVD Player (DVDP), a HDD Recorder (HDDR), a Portable Multimedia Player (PMP), or the like. Here, the BDP refers to a high-density optical disk player having tens of gigabytes of storage space.

The media information collection unit 110 may collect information on media that can be processed by a device within a home network. More specifically, the media information collection unit 110 may collect information on media included in the respective devices within the home network, such as the types of media that are present, the titles of content, and whether the media has been played back, periodically or according to user commands.

For example, when the DVDP and BDP are connected to the home network and a DVD “The Simpsons” that has been played back and a VCD “The Godfather” that has not been played back are inserted in the respective devices, the media information collection unit 110 may collect information such as “DVD”, “The Simpsons” and “has been played back” as media information provided in the DVDP, and may collect information such as “VCD”, “The Godfather” and “has not been played back” as media information provided in the BDP.

Here, types of media refer to the types of disks that are classified according to the recording capacity and recording method, and may include a Blue-ray Disc, a DVD, a VCD, or the like, and may further include various types of content that can be implemented on devices other than the disks within the home network. The titles of content refer to titles of content stored on the disk, for example, titles of movies in the case that the stored content contains movies, and titles of music tracks in the case that the stored content contains music.

Information on the titles of content may be known through tags provided on the disks. If tags relevant to the titles of contents are not provided on the disks, at least the types of media corresponding to the disks may be collected as information on the media. Furthermore, information about whether the corresponding disk has been played back on the same device and the playback time when the corresponding disk was played back may also be collected as information on the media, in addition to the type of media and titles of content.

When a disk is not provided in the corresponding device or a disk inserted in the device is not a type that can be played back in the corresponding device, information that the disk cannot be reproduced may also be collected.

When the control device 100 is implemented as a predetermined device within a home network instead of the remote controller, for example, a digital TV, the media information collection unit 110 receives the information on media directly from the devices through two-way communications with a plurality of devices within a home network, making it possible to collect information on media included in the devices.

The control device 100 is implemented as a remote controller of a digital TV that can control a plurality of devices, and the media information collection unit 110 receives information on other devices and media using a server such as a digital TV that becomes a center of the devices within the home network, making it possible to collect information on media included in the devices.

The control unit 120 may generate a task list for tasks that can be performed based on the information on media collected by the media information collection unit 110. More specifically, the control unit 120 may generate a task list by collecting titles of content included in the respective devices. In other words, when the titles of content are included in the information on media collected by the media information collection unit 110, the control unit 120 may generate a task list corresponding to the titles of content.

For example, when i) “DVD”, ii) “The Simpsons” and iii) “has been played back” are received as information on media provided in the DVDP and i) “VCD”, ii) “The Godfather” and iii) “has not been played back” are received as information on media provided in the BDP from the media information collection unit 110, the control unit 120 checks whether the information on the titles of content is included in the information on the collected media. When the information on the titles of content is included in the information on the collected media, the control unit 120 may generate a task list by naming the titles of tasks for the respective media as “play the Simpsons” and “play the Godfather” so as to correspond to the titles of the content.

When a plurality of inserted media have the same titles of content, the control unit 120 may generate a task list using additional information. For example, when different types of media (such as a DVD and a VCD) having the same title “The Simpsons” are provided in the respective devices (device 1 and device 2), the control unit 120 may generate a task list such that the respective devices have the respective titles of tasks, such as “play The Simpsons DVD” and “play The Simpsons VCD” or “play The Simpsons-device 1” and “play The Simpsons-device 2”.

The control unit 120 may generate a task list by collecting information on the types of media included in each device. More specifically, when the titles of content are not included in the information on the collected media, the control unit 120 may generate a task list corresponding to each type of media. For example, when i) “DVD” and ii) “has been played back” are received as information on media provided in the DVDP, and i) “VCD” and ii) “has not been played back” are received as information on media provided in the BDP from the media information collection unit 110, the control unit 120 may generate a task list by naming the titles of tasks for the respective media as “play DVD” and “play VCD” so as to correspond to the type of media included in the information on the collected media.

When the plurality of media are of the same type, the control unit 120 may also generate a task list using additional information. For example, when media of the same type are provided in each respective device (device 1 and device 2), the control unit 120 may generate a task list by naming the titles of tasks for the respective media as “play VCD-device 1” and “play VCD-device 2”. Alternately, the control unit 120 may also generate a task list by naming the titles of tasks for the respective media as “play VCD-new media” and “play VCD-reproduction time”.

Here, a task refers to operations for playing back the media provided in each of the plurality of devices within the home network. More specifically, a task refers to a series of operations by which devices operate together in order to operate the device in which the media to be played back by a user is provided and the media corresponding to the device. Tasks may be preset, may be generated based on profiles collected by the devices within the home network, or may be generated by user selection.

When a new medium is inserted in a device within the home network, the control unit 120 may control the media information collection unit 110 to receive information on the newly inserted medium, and may update an existing task list according to the information received using the media information collection unit 110.

When a task is selected from the task list, the control unit 120 may control processing operations for the medium corresponding to the selected task. More specifically, the control unit 120 may perform a preset task corresponding to the selected medium. For example, when a user desires to play back a VCD using a DVDP device, the control unit 120 performs a “VCD playback” task corresponding to a series of operations including turning on a TV, DVDP and HTS, setting the TV to a movie playback mode, setting the HTS to a surround mode, and initiating VCD media playback on the DVDP.

The display unit 130 displays the task list generated by the control unit 120. In other words, the display unit 130 displays the task list generated by the control unit 120 as a menu in order that the user can select the tasks. The displayed task list may be implemented using soft keys so that the user can select the tasks by touching the display unit 130 itself, or may be implemented using buttons (not shown) provided in the control device (100) itself.

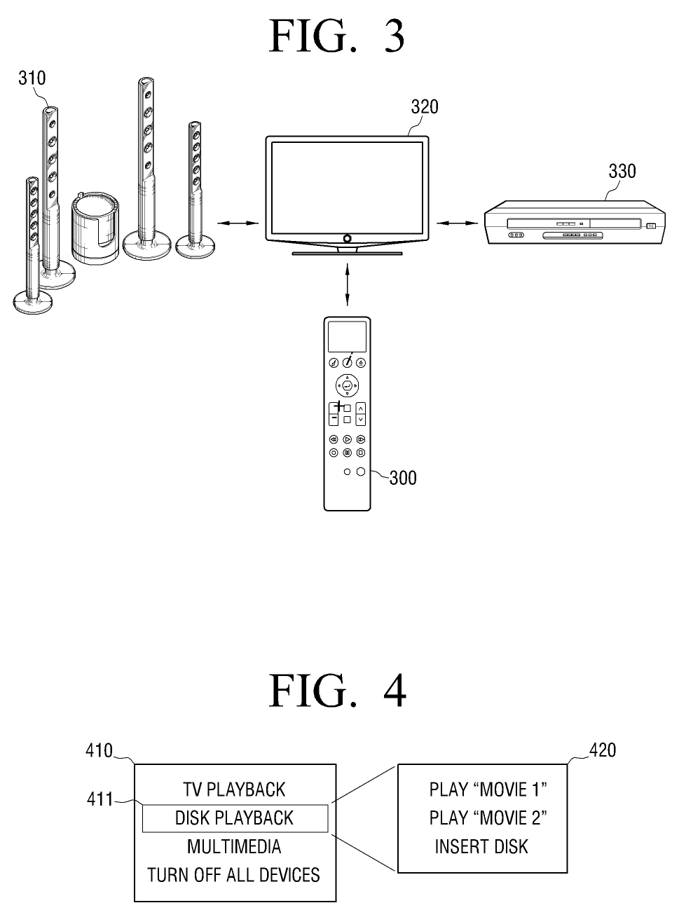

Here, the display unit 130 may be implemented as a digital TV 220 or a Liquid Crystal Display (LCD) provided on a remote controller 200 as shown in following FIGS. 2 and 3, or may alternatively be implemented as a Cathode-Ray Tube (CRT), a Plasma Display Panel (PDP), an Organic Light Emitting Diodes (OLED), or the like, as needed.

When the types of media are included in information on the collected media, the display unit 130 may display the tasks using icons corresponding to each type of media. More specifically, the display unit 130 may display media currently provided in the devices within the home network by displaying a DVD icon when the corresponding media type is a DVD, and displaying a VCD icon when the corresponding media type is a VCD. More specific examples will be described later with reference to FIG. 6.

The control device 100 displays the information on media currently provided in the home network, so the user may easily know what media are provided in the home network. The user may control the operations of the plurality of devices required for the playback environment of the provided media by selecting the task displayed as a menu, so user convenience is improved.

FIGS. 2 and 3 are diagrams showing a configuration of a home network system including the control device of FIG. 1 according to an exemplary embodiment of the present invention.

Referring to FIG. 2, the control device 100 of FIG. 1 is implemented as a remote controller 200 and is able to perform two-way communications with a plurality of devices within a home network, such as an HTS 210, a TV 220 and a BDP 230. When a user requests information on media present, the control device 100 may receive information on media provided in the HTS 210, TV 220 and BDP 230 directly from the corresponding devices, and generate a task list based on the received information on the media present. The remote controller 200 may also directly transmit control signals for the respective devices corresponding to the respective tasks according to the user's selection for the tasks.

Referring to FIG. 3, the control device 100 of FIG. 1 may be implemented as either a remote controller 300 or a TV 320. In this case, the TV 320 may perform two-way communications with other devices within a home network, such as an HTS 310 and a BDP 330.

When the control device 100 is implemented as the remote controller 300, the TV 320 may function to collect information on media provided in the HTS 310 and BDP 330 from the corresponding devices, and to transmit the information on media present to the remote controller 300, and the remote controller 300 may generate a task list based on the information on media present in the devices received from the TV 320. The remote controller may also be implemented such that the control signals of the corresponding device may be transferred using the TV 320 in order to operate the respective devices corresponding to the relevant tasks according to the user's selection for the tasks. The remote controller 300 may also be implemented to transmit one-way control signals directly to the HTS 310 and BDP 330.

When the control device 200 is implemented as the TV 320, the remote controller 300 functions to simply transfer the user's control command to the TV 320, and the TV 320 may receive information on media from the HTS 310 and BDP 330 to generate a task list based on the received information on the media present. The TV 320 may also transmit the control signals for the respective devices corresponding to the relevant tasks according to the user's selections on the tasks received directly using the remote controller 200.

In the present exemplary embodiment, a home network having three devices is described as an example, but there is no limitation in the number of devices that can be connected to the home network. The present exemplary embodiment is provided to explain the relationship between the devices within the home network and the control device, so a detailed configuration of the remote controller is not described therein.

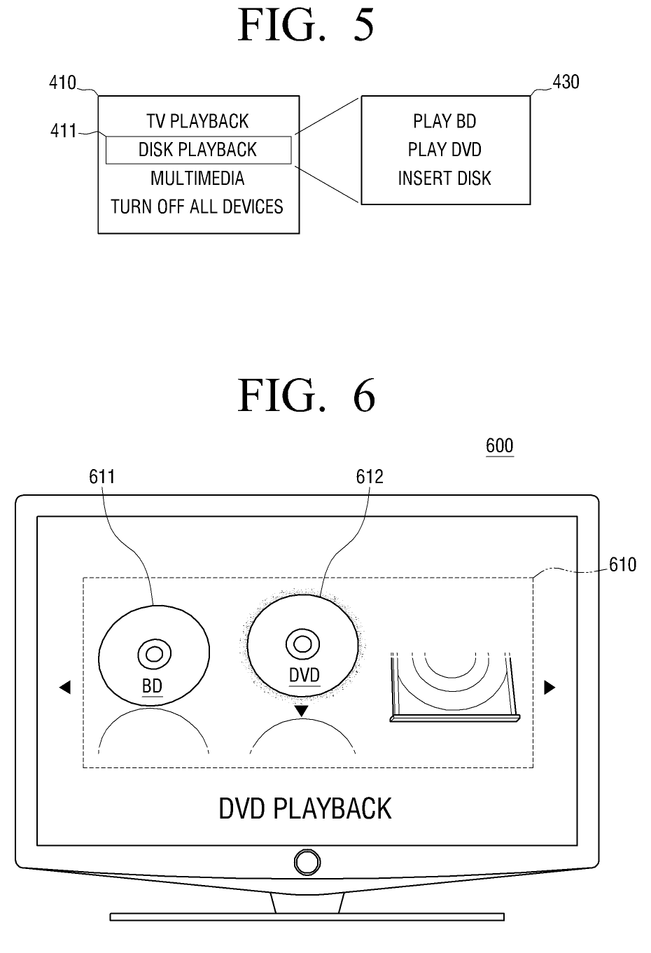

FIGS. 4 and 5 are diagrams showing a tasks display method according to an exemplary embodiment of the present invention.

FIG. 4 shows a form in which a task list corresponding to titles of content is displayed on a display unit 130 provided in the control device 100. For example, when a user selects a disk playback menu 411 from a basic menu 410, tasks such as “play movie 1” and “play movie 2” may be displayed in the form of a menu on a TV screen and a display screen 420 provided in a remote controller.

FIG. 5 shows a form in which a task list corresponding to the types of disk is displayed on a display unit 130 provided in the control device 100. For example, when a user selects a disk playback menu 411 from a basic menu 410, tasks such as “play BD” and “play DVD” corresponding to the types of media may be displayed in the form of a menu on a TV screen and a display screen 430 provided in a remote controller

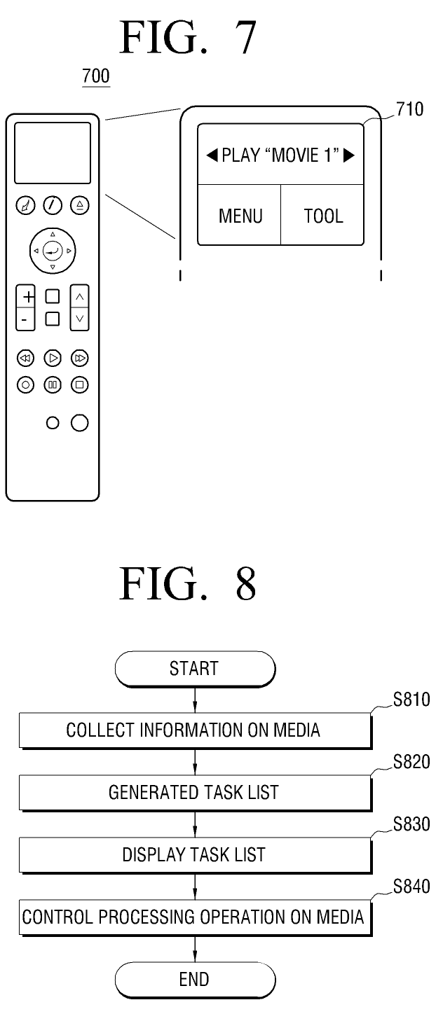

FIGS. 6 and 7 are diagrams showing detailed embodiments of display shapes according to FIGS. 4 and 5.

FIG. 6 shows a form of display in which a menu required for performing generated tasks is displayed on a display unit 610 provided in a TV 600. More specifically, when the tasks generated by the control unit 130 are “play DVD” and “play BD”, a DVD icon 612 corresponding to the tasks “play DVD” and a BD icon 611 corresponding to the “play BD” may be displayed. When a user selects the corresponding icon, the corresponding task is performed. For example, when the user selects the DVD icon 612, the operation required for the task “play DVD” corresponding to the DVD icon is performed.

FIG. 7 shows a form of display in which a menu required for performing generated tasks is displayed on a display unit 710 provided in a remote controller 700.

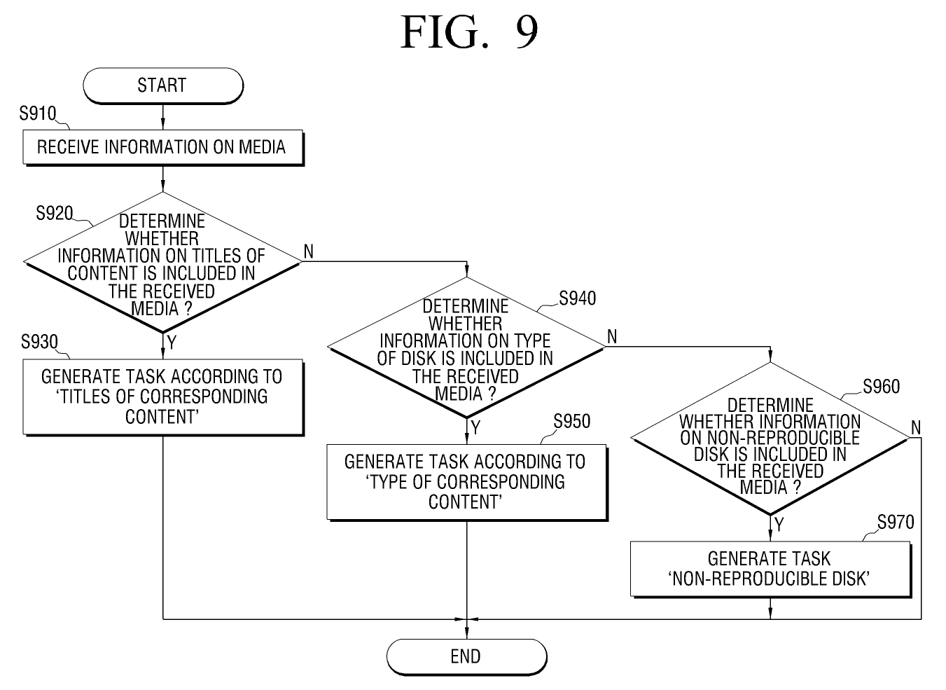

FIG. 8 is a flowchart explaining a control method of a control device according to an exemplary embodiment of the present invention, and FIG. 9 is a detailed flowchart explaining the operations of generating tasks.

Referring to FIG. 8, information on media that can be processed by devices within a home network is first collected in operation S810. More specifically, information on media included in the respective devices within the home network, such as the types of media, the titles of content, and the playback information on the media, are collected periodically or according to user commands.

When the collection of information on media included in the devices within the home network is completed, a task list is generated based on the information on the collected media in operation S820. A detailed operation for generating the task list will be described hereinafter, with reference to FIG. 9.

Referring to FIG. 9, when information on media included in devices within a home network is received in operation S910, whether information on titles of content is included in the received media is determined in operation S920. When the information on the titles of content is included in the received media as a result of operation S920, a task list according to the titles of the corresponding content is generated in operation S930. For example, when “DVD”, “The Simpsons” and “has been played back” are received as information on media provided in the DVDP, and “VCD”, “The Godfather” and “has not been played back” are received as information on media provided in the BDP, the titles of content are included in the information on the collected media, so a task list naming the tasks for the respective media as “play The Simpsons” and “play The Godfather” may be generated so as to correspond to the respective titles of the content.

When the titles of media are not included in the information on the media, whether information on the types of disk is included in the information on the received media is determined in operation S940. When the information on the types of disk is included in the received media as a result of operation S940, a task list for each type of disk is generated in operation S950. For example, when i) “DVD” and ii) “has been played back” are received as information on media provided in the DVDP from the media information collection unit 110, and “VCD” and “has not been played back” are received as information on media provided in the BDP from the media information collection unit 110, the control unit 120 may generate a task list naming the tasks for the respective media as “play DVD” and “play VCD” so as to correspond to the types of media included in the information on the collected media.

When the information on the titles of the content and the types of disk is not included in the information on media, whether information on a non-reproducible disk is included therein is determined in operation S960. Here, the information on a non-reproducible disk means that a disk is not currently included in a device or an inserted disk is the type of disk that cannot be played back in the corresponding device. When the information on a non-reproducible disk is included in the information on media, a task “non-reproducible disk” is generated in operation S970.

In FIG. 9, a task generating process corresponding to information on a single medium is described, but such a generating process is performed on the information on each of the media currently received from devices within a home network. When the corresponding device has a plurality of trays, the generating process is also performed on the media provided in each tray. When the inserted plurality of media have the same titles of content, a task list may be generated using additional information. For example, when a DVD and a VCD having the same title “The Simpsons” are provided in the devices within the home network, a task list may be generated by naming the respective media as “play The Simpsons DVD” and “play The Simpsons VCD”. A task list may also be generated by naming the respective media “play the Simpsons-device 1” and “play the Simpsons-device 2”.

When a new medium is inserted in the home network, information on the new media is collected, and a task list may be updated based on the collected information on the medium.

When the task list generating operation is completed, the generated task list is displayed to a user in operation S830. When the user selects one task from the task list, the operation of the media corresponding to the selected task may be controlled in operation S840. More specifically, the corresponding device may be controlled so that the device including the media corresponding to the selected task operates in an operational mode corresponding to the type of media.

The user may thus know the information on media currently provided within the home network using information displayed without opening and checking the tray of the corresponding device. The user may select the media to be played back using a menu generated based on the media, making it possible to play back the corresponding medium using a single button.

According to the diverse embodiments of the present invention, a user may control devices using a menu generated based on the media included in the devices within a home network, making it possible to improve convenience to the user.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A control device, comprising:
a media information collection unit which collects information on media that is processed by devices within a home network;
a control unit which generates a task list for tasks that are performed based on the collected information; and
a display unit which displays the generated task list.

2. The control device as claimed in claim 1, wherein, when the collected information includes information on types of media, the display unit displays the tasks using icons corresponding to each type of media.

3. The control device as claimed in claim 1, wherein, when a task is selected from the task list, the control unit controls processing operations for the media corresponding to the selected task.

4. The control device as claimed in claim 3, wherein, when a device that can perform the selected task has a plurality of operational modes, the control unit controls the device to operate in an operational mode corresponding to the selected task.

5. The control device as claimed in claim 1, wherein the media information collection unit collects information on media periodically or according to user commands, and the control unit updates the task list according to the collected information.

6. The control device as claimed in claim 1, wherein the control unit collects information on types of media included in the devices to generate the task list.

7. The control device as claimed in claim 1, wherein the control unit collects titles of content included in the respective devices to generate the task list.

8. The control device as claimed in claim 1, wherein the media information collection unit collects the information on the media included in the devices by receiving the information on the media directly from the devices.

9. The control device as claimed in claim 1, wherein the media information collection unit collects the information on the media included in the devices by receiving the information on the media indirectly from one of the devices.

10. A control method, comprising:
collecting information on media that is processed by devices within a home network;
generating a task list for tasks that are performed based on the collected information; and
displaying the generated task list.

11. The control method as claimed in claim 10, wherein the displaying the generated task list comprises displaying the tasks using icons corresponding to each type of media, when the collected information includes types of media,

12. The control method as claimed in claim 10, further comprising:
controlling processing operations for the media corresponding to a selected task, when a task is selected from the task list.

13. The control method as claimed in claim 12, wherein the controlling of the processing operations comprises controlling a device to operate in an operational mode corresponding to the selected task, when the device that can perform the selected task has a plurality of operational modes.

14. The control method as claimed in claim 10, wherein the collecting of the information comprises collecting information on media periodically or according to user commands, and the generating of the task list comprises updating the task list according to the collected information.

15. The control method as claimed in claim 10, wherein the generating of the task list comprises collecting information on the types of media in the devices to generate the task list.

16. The control method as claimed in claim 10, wherein the generating of the task list comprises collecting titles of content included in the devices to generate the task list.

17. The control method as claimed in claim 10, wherein the collecting of the information comprises collecting the information on the media included in the devices by receiving the information on the media directly from the devices.

18. The control method as claimed in claim 10, wherein the collecting of the information comprises collecting the information on the media included in the devices by receiving the information on the media indirectly from one of the devices.
